(19) United States
(12) Patent Application Publication
(10) Pub. No.: US 2021/0101264 A1
(43) Pub. Date: Apr. 8, 2021

(54) POWER RATCHET TOOL CAPABLE OF ACCESSING NARROW AND ELONGATED SPACES

(71) Applicant: Jian-Shiou LIAW, Taichung City (TW)

(72) Inventor: Jian-Shiou LIAW, Taichung City (TW)

(21) Appl. No.: 16/594,335

(22) Filed: Oct. 7, 2019

(51) Int. Cl. B25B 21/00; B25B 13/46

(52) U.S. Cl. CPC B25B 21/004; B25B 13/481; B25B 13/46

(57) ABSTRACT

A power ratchet tool capable of accessing narrow and elongated spaces includes a handle, a head, and a mounting cover. The handle has a transmission device having an idler and an eccentric spindle. The idler has a toothed portion. The eccentric spindle has a gear portion and an abutting portion. The gear portion engages with the toothed portion. The head is mounted to the handle and has a length being between 3 inches and 28 inches, an extended housing and a bushing. The extended housing is mounted to the handle and has a receiving groove. The receiving groove is recessed in the extended housing. The bushing is received in the receiving groove. The handle and the head are mounted together by the mounting cover. The abutting portion of the eccentric spindle abuts against the bushing, such that the bushing sleeves the eccentric spindle.

### BACKGROUND OF THE INVENTION

### 1. Field of the Invention

The present invention relates to a power ratchet tool, and more particularly to a power ratchet tool capable of accessing narrow and elongated spaces.

### 2. Description of Related Art

With reference to FIGS. 6 and 7, a conventional power ratchet tool includes a handle 40, a head 50, and a mounting cover 60. The handle 40 has a transmission shaft 41 having a rotating plate 411 and an eccentric spindle 412. The rotating plate 411 is formed on an end of the transmission shaft 41. An end of the eccentric spindle 412 is integrally mounted to the rotating plate 411, and the eccentric spindle 412 extends along an axial direction of the rotating plate 411. The eccentric spindle 412 has an eccentric spindle peg 413 protruding eccentrically on an end of the eccentric spindle 412 away from the rotating plate 411, and the eccentric spindle peg 413 extends into the head 50. In this way, the transmission shaft 41 can transmit force to a ratchet actuator 51 of the head 50 while rotating. The head 50 is mounted to the handle 40, and the head 50 has a length shorter than 3 inches. The length of the head 50 is shorter than that of the handle 40. The mounting cover 60 is mounted to an outer surface of the handle 40 and an outer surface of the head 50, and thus the handle 40 and the head 50 are mounted together by the mounting cover 60.

When a component that needs detachment is located in a narrow and elongated space, the conventional power ratchet tool would not be able to access the narrow and elongated space due to its short length. The practicality of the conventional power ratchet tool is therefore decreased.

To enhance the practicality of the conventional power ratchet tool, the length of the head 50 should be extended. In such a configuration, a length of the eccentric spindle 412 of the transmission shaft 41 should also be extended in order to make the eccentric spindle peg 413 extend into the head 50. However, since the eccentric spindle 412 is integrally mounted to the rotating plate 411, the transmission shaft 41 may crack at the position where the eccentric spindle 412 and the rotating plate 411 joint in transmission after the transmission shaft 41 is extended. Moreover, due to a lack of mechanism preventing the transmission shaft 41 from vibrating, the transmission shaft 41 may vibrate in transmission after the transmission shaft 41 is extended.

To overcome the shortcomings of the conventional power ratchet tool, the present invention tends to provide a power ratchet tool capable of accessing narrow and elongated spaces to mitigate or obviate the aforementioned problems.

### SUMMARY OF THE INVENTION

The main objective of the present invention is to provide a power ratchet tool capable of accessing narrow and elongated spaces.

The power ratchet tool capable of accessing narrow and elongated spaces includes a handle, a head, and a mounting cover. The handle has a switch device, a driving device, and a transmission device. The switch device is mounted to the handle. The driving device is disposed in the handle and is mounted to the switch device. The transmission device is mounted to the driving device and has an idler and an eccentric spindle. The idler is located in the handle, is mounted to the driving device, and has a toothed portion formed within. The eccentric spindle has two opposite ends, a gear portion, an abutting portion, an eccentric spindle peg, and a middle portion. The gear portion is disposed annularly on one of the two opposite ends of the eccentric spindle, extends into the idler, and engages with the toothed portion of the idler. The abutting portion is formed on the other one of the two opposite ends of the eccentric spindle and is away from the gear portion. The eccentric spindle peg protrudes eccentrically on the abutting portion along an axial direction of the eccentric spindle. The middle portion is formed on the eccentric spindle, is located between the gear portion and the abutting portion, and has an outer diameter smaller than outer diameters of two ends of the middle section of the eccentric spindle.

The head is mounted to the handle and has a length, an extended housing, a bushing, and a ratchet actuator. The length of the head is between 3 inches and 28 inches, and the length of the head is longer than a length of the handle. The extended housing is mounted to the handle and has two opposite ends, a containing space, a receiving groove, and a through hole. One of the two opposite ends of the extended housing is adjacent to the handle, and the other one of the two opposite ends of the extended housing is away from the handle. The containing space is formed in the extended housing adjacent to the handle. The receiving groove is recessed in the extended housing away from the containing space. The through hole is formed between the containing space and the receiving groove, communicates with both the containing space and the receiving groove, and has an inner diameter smaller than both an inner diameter of the containing space and an inner diameter of the receiving groove. The bushing is received in the receiving groove. The ratchet actuator is mounted to the eccentric spindle peg of the eccentric spindle.

The eccentric spindle extends through the bushing, the through hole, and the containing space, and is mounted to the idler of the transmission device. The abutting portion of the eccentric spindle abuts against the bushing, such that the bushing sleeves a portion of the eccentric spindle that is adjacent to the abutting portion.

The mounting cover is mounted to an outer surface of the handle and an outer surface of the extended housing, such that the handle and the head are mounted together by the mounting cover.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a power ratchet tool capable of accessing narrow and elongated spaces in accordance with the present invention;

FIG. 2 is an exploded perspective view of the power ratchet tool capable of accessing narrow and elongated spaces in FIG. 1;

FIG. 3 is a partial cross-sectional side view of the power ratchet tool capable of accessing narrow and elongated spaces in FIG. 1;

FIG. 3A is an enlarged cross-sectional side view of the power ratchet tool capable of accessing narrow and elongated spaces in FIG. 1;

FIG. 3B is another enlarged cross-sectional side view of the power ratchet tool capable of accessing narrow and elongated spaces in FIG. 1;

FIG. 4 is an enlarged cross-sectional side view of the power ratchet tool capable of accessing narrow and elongated spaces in FIG. 1;

FIG. 5 is another enlarged cross-sectional side view of the power ratchet tool capable of accessing narrow and elongated spaces in FIG. 1;

FIG. 6 is a partial cross-sectional side view of a power ratchet tool in accordance with the prior art; and

FIG. 7 is an exploded perspective view of the power ratchet tool in FIG. 6.

### DETAILED DESCRIPTION OF THE PREFERRED EMBODIMENT

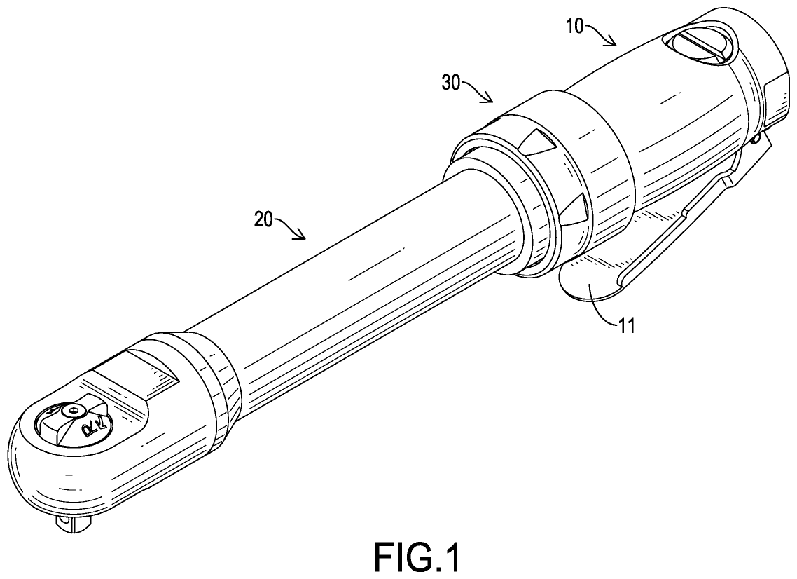

With reference to FIGS. 1 to 3, a power ratchet tool capable of accessing narrow and elongated spaces in accordance with the present invention includes a handle 10, a head 20, and a mounting cover 30.

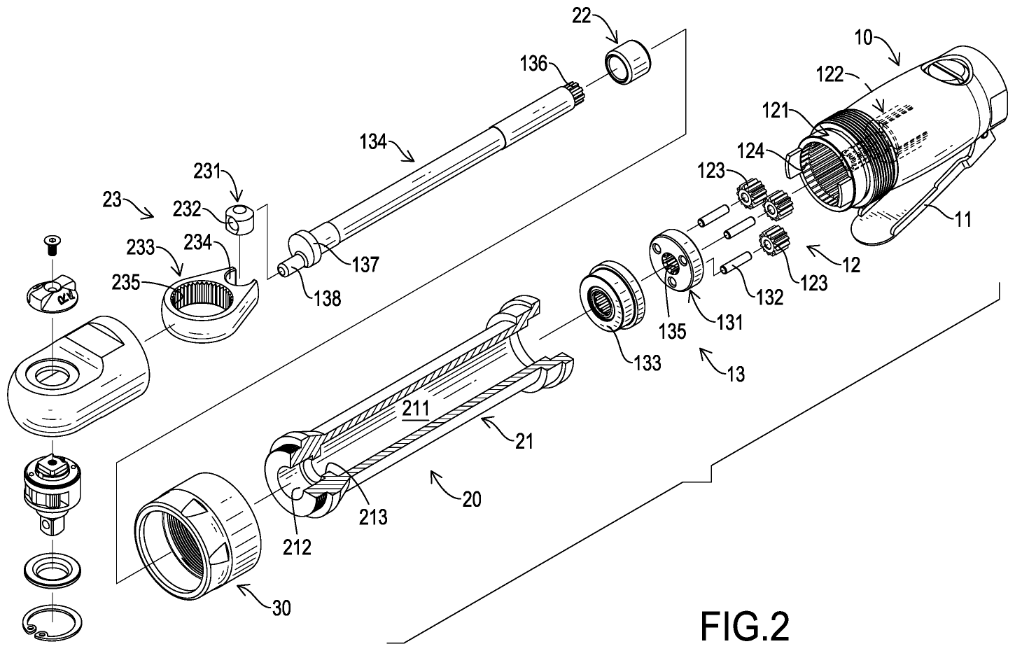

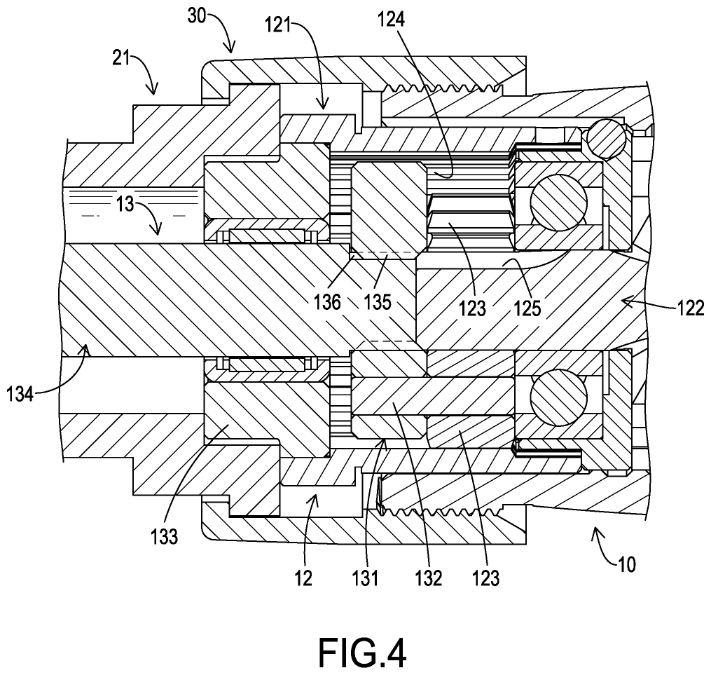

With reference to FIGS. 1 and 2, the handle 10 has a switch device, a driving device 12, and a transmission device 13. The switch device has a switch 11, and the switch 11 is pivotally mounted on an outer surface of the handle 10. Since other components of the switch device and assembly of the other components are conventional, details thereof will not be described. With reference to FIGS. 2 and 4, the driving device 12 is disposed in the handle 10, is mounted to the switch device, and has a sleeve 121, a driving spindle 122, and multiple planetary gears 123. The sleeve 121 is mounted on an inner surface of the handle 10 annularly, has an end extending out of the handle 10, and has a toothed segment 124 disposed on an inner surface of the sleeve 121 annularly. The driving spindle 122 is mounted to the switch device and is located within the handle 10. An end of the driving spindle 122 extends into the sleeve 121, and the end extending into the sleeve 121 has a gear segment 125 disposed annularly thereon. The multiple planetary gears 123 are disposed between the driving spindle 122 and the sleeve 121, and the multiple planetary gears 123 are disposed at spaced intervals. Each one of the multiple planetary gears 123 engages with the gear segment 125 of the driving spindle 122 and the toothed segment 124 of the sleeve 121. In the present invention, the driving device 12 has three planetary gears 123 disposed at spaced intervals around the gear segment 125 of the driving spindle 122.

With reference to FIGS. 2 and 4, the transmission device 13 is mounted to the driving device 12, and the transmission device 13 is propelled by the driving device 12 after the driving device 12 is actuated. The transmission device 13 has an idler 131, multiple connecting rods 132, a bearing assembly 133, and an eccentric spindle 134. The idler 131 is located in the sleeve 121, is adjacent to the multiple planetary gears 123, and has a toothed portion 135. The toothed portion 135 is formed within the idler 131. Each one of the multiple connecting rods 132 has two opposite ends. One of the two opposite ends of each one of the multiple connecting rods 132 is mounted to one of the multiple planetary gears 123, the other one of the two opposite ends of each one of the multiple connecting rods 132 is mounted to the idler 131. That is, the idler 131 is mounted to the multiple planetary gears 123 via the multiple connecting rods 132. The bearing assembly 133 is mounted to the end of the sleeve 121 that extends out of the handle 10.

The eccentric spindle 134 has two opposite ends, a gear portion 136, an abutting portion 137, an eccentric spindle peg 138, and a middle section. The gear portion 136 is disposed annularly on one of the two opposite ends of the eccentric spindle 134. The gear portion 136 of the eccentric spindle 134 extends into the idler 131 via the bearing assembly 133, and the gear portion 136 engages with the toothed portion 135 of the idler 131. After the gear portion 136 is mounted to the toothed portion 135 of the idler 131, the bearing assembly 133 sleeves the eccentric spindle 134 as shown in FIG. 4.

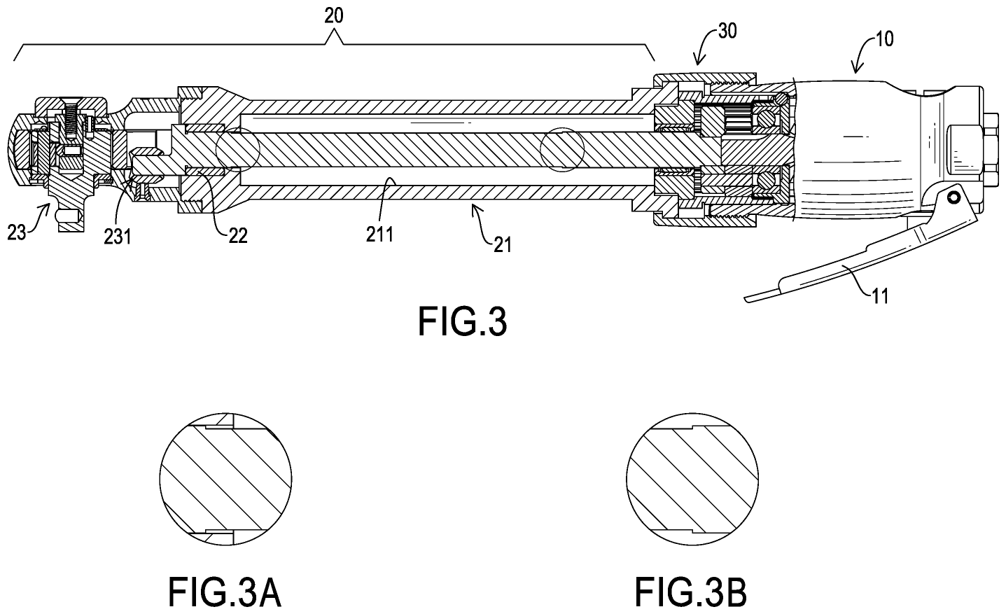

The abutting portion 137 is formed on the other one of the two opposite ends of the eccentric spindle 134, and is away from the gear portion 136. The eccentric spindle peg 138 protrudes eccentrically on the abutting portion 137 along an axial direction of the eccentric spindle 134. With reference to FIG. 3, 3A, and 3B, the middle section is formed on the eccentric spindle 134 and is located between the gear portion 136 and the abutting portion 137. An outer diameter of the middle section of the eccentric spindle 134 is smaller than outer diameters of two ends of the middle section, such that weight of the eccentric spindle 134 is decreased.

When a user presses the switch 11 of the switch device, the driving device 12 is actuated. Then the driving spindle 122 rotates and propels each one of the multiple planetary gears 123 to rotate. As the idler 131 is mounted to the multiple planetary gears 123 via the multiple connecting rods 132, force is transmitted to the idler 131 at a decreased rotation speed. Since the gear portion 136 of the eccentric spindle 134 engages with the toothed portion 135 of the idler 131, the idler 131 transmits force to the eccentric spindle 134 and propels the eccentric spindle 134 to rotate. Sleeving the eccentric spindle 134, the bearing assembly 133 enables the eccentric spindle 134 to rotate smoothly.

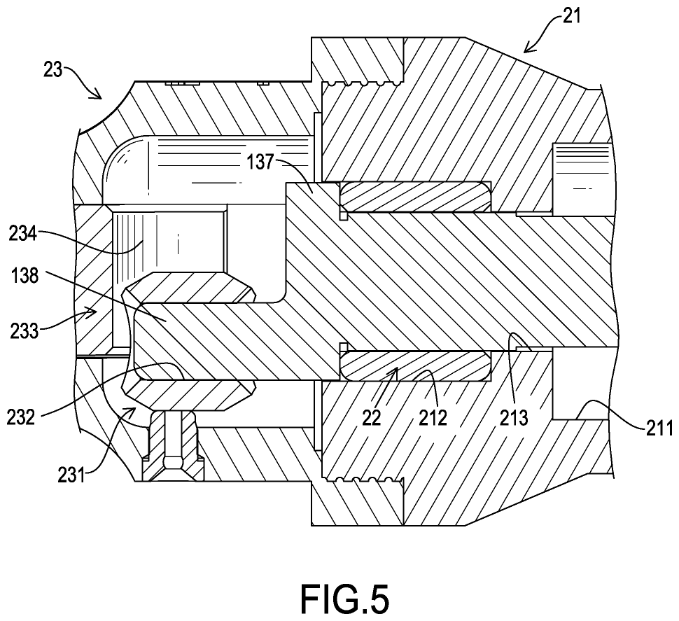

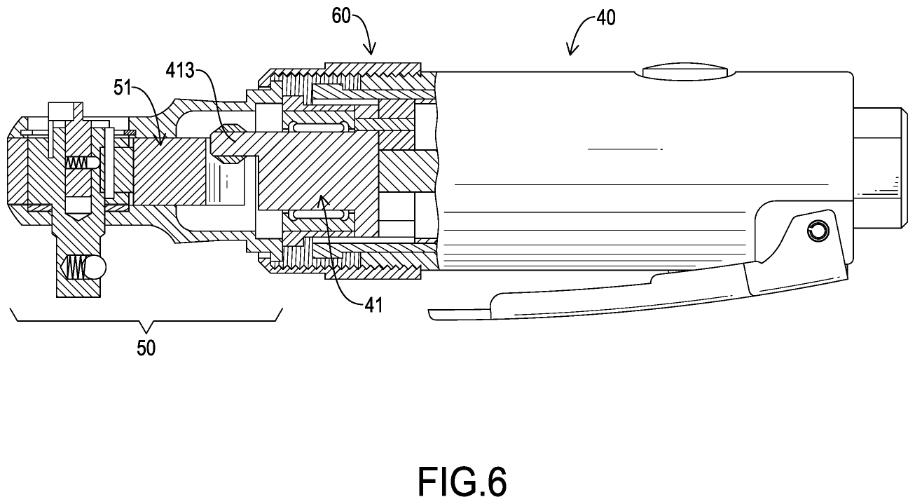

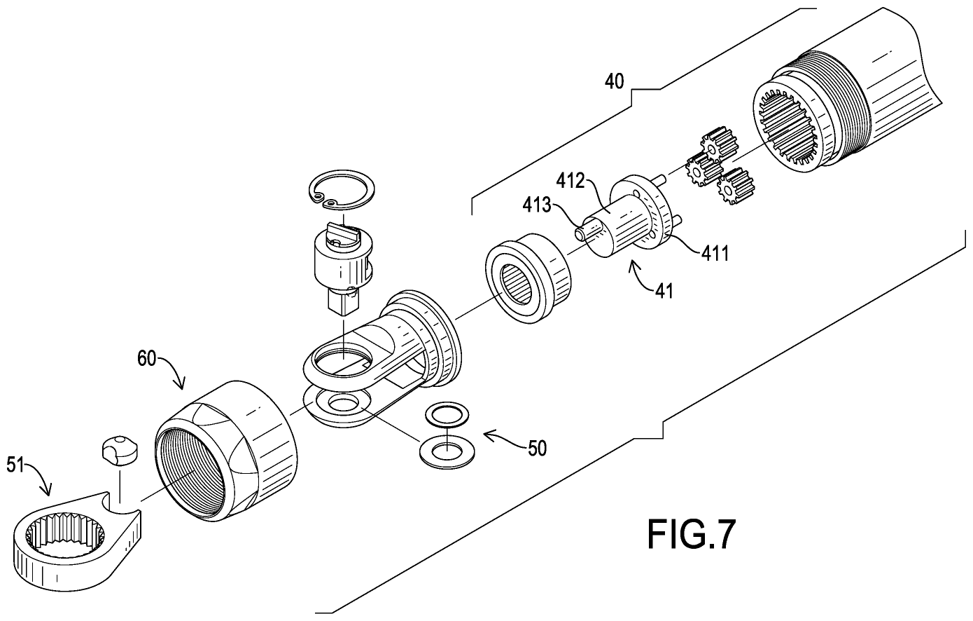

With reference to FIGS. 2 to 4, the head 20 is mounted to the handle 10 and has a length being between 3 inches and 28 inches, and the length of the head 20 is far longer than a length of the handle 10. The head 20 has an extended housing 21, a bushing 22, and a ratchet actuator 23. With reference to FIGS. 2, 3, and 5, the extended housing 21 has two opposite ends, a containing space 211, a receiving groove 212, and a through hole 213. One of the two opposite ends of the extended housing 21 is adjacent to the handle 10, the other one of the two opposite ends of the extended housing 21 is away from the handle 10. With reference to FIG. 4, the end of the extended housing 21 adjacent to the handle 10 abuts against the end of the sleeve 121 extending out of the handle 10 and sleeves a portion of the bearing assembly 133. The containing space 211 is formed in the extended housing 21 adjacent to the handle 10. The receiving groove 212 is recessed in the extended housing 21 away from the handle 10 and the containing space 211. The through hole 213 is formed between the containing space 211 and the receiving groove 212, and communicates with both the containing space 211 and the receiving groove 212. An inner diameter of the through hole 213 is smaller than both an inner diameter of the containing space 211 and an inner diameter of the receiving groove 212, such that a stepped structure is formed between the through hole 213 and the receiving groove 212. The bushing 22 is received in the receiving groove 212 as shown in FIG. 5. With reference to FIGS. 4 and 5, the eccentric spindle 134 extends through the bushing 22, the through hole 213, the containing space 211, and the bearing assembly 133, and then is mounted to the idler 131 of the transmission device 13. The abutting portion 137 of the eccentric spindle 134 abuts against the bushing 22, and thus the eccentric spindle 134 will not move toward the handle 10. The eccentric spindle 134 can rotate smoothly since the bushing 22 sleeves a portion of the eccentric spindle 134 that is adjacent to the abutting portion 137. At the same time, the bushing 22 prevents the eccentric spindle 134 from vibrating in rotation caused by an over-long length of the eccentric spindle 134.

With reference to FIGS. 2, 3, and 5, the ratchet actuator 23 is mounted to the eccentric spindle 134, and has a push block 231 and a driving ring 233. The push block 231 has a passing hole 232. The passing hole 232 is formed through the push block 231 along the axial direction of the eccentric spindle 134, and the eccentric spindle peg 138 of the eccentric spindle 134 extends into the passing hole 232 of the push block 231. The driving ring 233 has a recess 234 and a ratchet portion 235. The recess 234 is formed on the driving ring 233, is adjacent to the push block 231, and partially surrounds the push block 231. The ratchet portion 235 is formed through the driving ring 233. When the eccentric spindle 134 rotates, the eccentric spindle peg 138 rotates in the recess 234 of the driving ring 233 eccentrically. The push block 231 rotates eccentrically in the recess 234 of the driving ring 233 at the same time, and makes the driving ring 233 sway to and fro. Since configuration and operation of the ratchet actuator 23 are conventional, details thereof will not be described.

With reference to FIGS. 2 to 4, the mounting cover 30 is mounted to the outer surface of the handle 10 and an outer surface of the extended housing 21, and thus the handle 10 and the head 20 are mounted together by the mounting cover 30. When a component that needs detachment is located in a narrow and elongated space, extend the head 20 of the present invention into the narrow and elongated space. Next, press the switch 11 to actuate the driving device 12, and the driving device 12 propels the transmission device 13. Then the eccentric spindle 134 of the transmission device 13 transmits force to the ratchet actuator 23. In use, the eccentric spindle 134 can transmit force to the ratchet actuator 23 steadily without vibration.

The power ratchet tool capable of accessing narrow and elongated spaces in accordance with the present invention has the following advantages:

1. The length of the head 20 is between 3 inches and 28 inches, which is sufficiently longer than the length of the head 50 of the conventional power ratchet tool. Also, the length of the head 20 is far longer than the length of the handle 10. Thus, the present invention is capable of accessing narrow and elongated spaces, such that the practicality thereof is enhanced.

2. The gear portion 136 of the eccentric spindle 134 engages with the toothed portion 135 of the idler 131, such that force can be transmitted to the eccentric spindle 134 by the engagement of the gear portion 136 and the toothed portion 135 and makes the eccentric spindle 134 rotate. In such a configuration, the present invention prevents cracking at the position where the idler 131 and the eccentric spindle 134 joint by the engagement of the gear portion 136 and the toothed portion 135. Compared with configuration that the eccentric spindle 412 is integrally mounted to the rotating plate 411 of the conventional power ratchet tool, configuration of the transmission device 13 extends life expectancy of the present invention.

3. Since the eccentric spindle 134 and the idler 131 are two independent components, the user only has to replace the broken components when any of the two independent components is broken. However, as the eccentric spindle 412 of the conventional power ratchet tool is integrally mounted to the rotating plate 411, the user has to replace the whole transmission shaft 41 when either the rotating plate 411 or the eccentric spindle 412 is broken.

4. The bushing 22 sleeves the portion of the eccentric spindle 134 that is adjacent to the abutting portion 137, which enables the eccentric spindle 134 to rotate smoothly. At the same time, the bushing 22 prevents the eccentric spindle 134 from vibrating during rotation caused by the over-long length of the eccentric spindle 134. Furthermore, the abutting portion 137 of the eccentric spindle 134 abuts against the bushing 22, and thus the eccentric spindle 134 will not move toward the handle 10. Overall, the present invention is capable of transmitting force steadily since the bushing 22 prevents the eccentric spindle 134 from vibrating during rotation.

5. The extended housing 21 is disposed between the handle 10 and the ratchet actuator 23, such that the length of the head 20 can be extended without changing the structure of the ratchet actuator 23.

6. The outer diameter of the middle section of the eccentric spindle 134 is smaller than those of the two ends of the middle section, such that the weight of the eccentric spindle 134 is decreased. In such a configuration, the weight of the eccentric spindle 134 would not increase too much after the eccentric spindle 134 is extended.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A power ratchet tool capable of accessing narrow and elongated spaces comprising:
a handle having
a switch device mounted to the handle;
a driving device disposed in the handle and mounted to the switch device; and
a transmission device mounted to the driving device, and having
an idler located in the handle, mounted to the driving device, and having a toothed portion formed within; and
an eccentric spindle having
two opposite ends;
a gear portion disposed annularly on one of the two opposite ends of the eccentric spindle, extending into the idler, and engaging with the toothed portion of the idler;
an abutting portion formed on the other one of the two opposite ends of the eccentric spindle and being away from the gear portion;
an eccentric spindle peg protruding eccentrically on the abutting portion along an axial direction of the eccentric spindle; and
a middle portion formed on the eccentric spindle, located between the gear portion and the abutting portion, and having an outer diameter smaller than outer diameters of two ends of the middle section of the eccentric spindle;
a head mounted to the handle and having
a length being between 3 inches and 28 inches, and the length being longer than a length of the handle;
an extended housing mounted to the handle and having
two opposite ends, one of the two opposite ends of the extended housing being adjacent to the handle, and the other one of the two opposite ends of the extended housing being away from the handle;
a containing space formed in the extended housing adjacent to the handle;
a receiving groove recessed in the extended housing away from the containing space; and
a through hole formed between the containing space and the receiving groove, communicating with both the containing space and the receiving groove, and having an inner diameter smaller than both an inner diameter of the containing space and an inner diameter of the receiving groove;
a bushing received in the receiving groove; and
a ratchet actuator mounted to the eccentric spindle peg of the eccentric spindle; and
a mounting cover mounted to an outer surface of the handle and an outer surface of the extended housing, such that the handle and the head are mounted together by the mounting cover;
wherein the eccentric spindle extends through the bushing, the through hole, and the containing space, and is mounted to the idler of the transmission device, and the abutting portion of the eccentric spindle abuts against the bushing, such that the bushing sleeves a portion of the eccentric spindle that is adjacent to the abutting portion.

2. The power ratchet tool capable of accessing narrow and elongated spaces as claimed in claim 1, wherein the driving device has
a sleeve mounted on an inner surface of the handle and having a toothed segment disposed on an inner surface of the sleeve annularly;
a driving spindle mounted to the switch device, located within the handle, and having
an end extending into the sleeve and having a gear segment disposed annularly thereon; and
multiple planetary gears disposed between the driving spindle and the sleeve, disposed at spaced intervals, and each one of the multiple planetary gears engaging with the gear segment of the driving spindle and the toothed segment of the sleeve.

3. The power ratchet tool capable of accessing narrow and elongated spaces as claimed in claim 2, wherein the transmission device has multiple connecting rods, and each one of the multiple connecting rods has
two opposite ends, one of the two opposite ends of each one of the multiple connecting rods being mounted to one of the multiple planetary gears, the other one of the two opposite ends of each one of the multiple connecting rods being mounted to the idler.

4. The power ratchet tool capable of accessing narrow and elongated spaces as claimed in claim 3, wherein the transmission device has a bearing assembly mounted to an end of the sleeve that extends out of the handle, such that the bearing assembly sleeves the eccentric spindle.

5. The power ratchet tool capable of accessing narrow and elongated spaces as claimed in claim 3, wherein the driving device has three said planetary gears disposed at spaced intervals.

6. The power ratchet tool capable of accessing narrow and elongated spaces as claimed in claim 4, wherein the driving device has three said planetary gears disposed at spaced intervals.
